(19) United States
(12) Patent Application Publication
(10) Pub. No.: US 2005/0154891 A1
(43) Pub. Date: Jul. 14, 2005

(54) Metadata-based, anti-fraudulant identification card method and production system

(75) Inventor: Julie H. Skipper, Pittsford, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 10/753,832

(22) Filed: Jan. 8, 2004

(51) Int. Cl. H04L 9/00

(52) U.S. Cl. 713/176

(57) ABSTRACT

A method for verifying the authenticity of a secure document, the method includes the steps of encoding the secure document with one or more of steganographically encoded people identification, equipment identification, material identification or secure-document, production geographical location all associated with production of the secure document and all of which are not generally known to the public for forming metadata; scanning a secure document for obtaining the metadata: verifying the metadata with a database; and accepting identification by correctly matching one or more of the provided metadata.

### FIELD OF THE INVENTION

The invention relates generally to the field of authentication of secure documents and, more particularly, to embedding metadata in the secure document for authentication purposes.

### BACKGROUND OF THE INVENTION

Currently, secure documents such as a driver's license typically have the owners picture and personal data information for permitting authentication of the driver's license. Frequently, fraudulent copies of the driver's license have been obtained by putting a fraudulent owner's picture on the driver's license with the original owners personal data or the like.

Watermarking techniques, such as those in U.S. Pat. No. 6,343,138B1, described a technique for putting an invisible marker in such secure documents. In this technique, a scanner or the like scans a document and prohibits copying if a watermark, indicating a copyright or the like, is found.

Although satisfactory, this technique does not prevent someone from fraudulently obtaining watermark parameters and then putting this fraudulent watermark into the secure document. In this case, the fraudulent secure document could escape detection in the above-described technique because it includes a watermark.

Consequently, a need exists for putting metadata into the secure document so that even fraudulent watermarks and the like could be detected.

### SUMMARY OF THE INVENTION

The present invention is directed to overcoming one or more of the problems set forth above. Briefly summarized, according to one aspect of the present invention, the invention resides in a method for verifying the authenticity of a secure document, the method comprising the steps of (a) encoding the secure document with one or more of steganographically encoded people identification, equipment identification, material identification or secure-document, production geographical location all associated with production of the secure document and all of which are not generally known to the public for forming metadata; (b) scanning a secure document for obtaining the metadata; (c) verifying the metadata with a database; and (d) accepting identification by correctly matching one or more of the provided metadata.

These and other aspects, objects, features and advantages of the present invention will be more clearly understood and appreciated from a review of the following detailed description of the preferred embodiments and appended claims, and by reference to the accompanying drawing.

### ADVANTAGEOUS EFFECT OF THE INVENTION

The present invention has the advantage of detecting fraudulent watermarks in secure documents.

### BRIEF DESCRIPTION OF THE DRAWINGS

FIG. 1 is a functional overview drawing of the present invention.

### DETAILED DESCRIPTION OF THE INVENTION

Before discussing the present invention in detail, it is instructed to having a understanding of terms used herein such secure document. In this regard, secure document, by way of example only, includes an identification badge, driver's license, birth certificate, passport, visa, certificate of authenticity, legal document, diploma, currency or stocks and bonds as the secure document. Generally, secure documents are anything of personal, commercial, legal, or legal tender that has a need for validation and authentication of its source or authenticity.

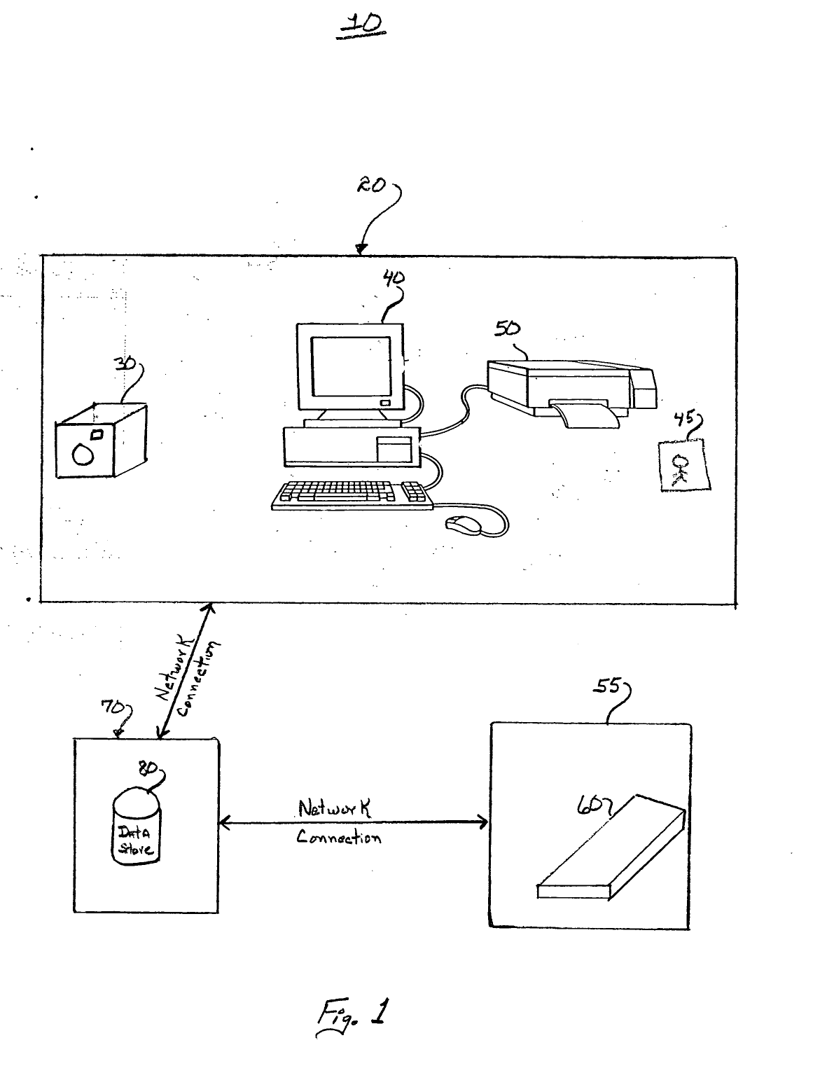

Referring to FIG. 1, there is shown a secure document system 10 of the present invention. The system 10 includes an image capture facility 20 operated by an authorized secure document producer, such as an official state-operated driver's license facility. The image capture facility 20 preferably includes a digital camera or film capture followed by film digitization with capture specific metadata 30 for capturing a digital image of a person, i.e., an ID holder. The image capture facility 20 also includes a personal computer 40 connected to the digital camera 30, which computer 40 includes an algorithm for embedding a watermark representing metadata into the digital image. The watermark may be created according to the technique described in U.S. Pat. No. 5,859,920, which is entitled Method For Embedding Digital Information In An Image, by Daly el al. and assigned to the Eastman Kodak Company. A digital output 50, such as a printer, is connected to the digital camera 30 and personal computer 40 for outputting hardcopy digital images having the watermark embedded therein 45. Alternatively, the watermark could be a visible, one or two dimension bar code or any other suitable visible identification. Bar code production is well known in the art and will not be discussed in detail herein.

The watermark includes such metadata as the global positioning identification (implemented by a global positioning system), site identification, captured equipment identification, printer or media/material identification, operator identification and image processing specification, look-up table for capture, device operation status, printing and/or generic identification. Such metadata is unique in that obtaining it fraudulently is virtually impossible. The capture, processing, and output metadata might specifically include, for example, device identifications, device status or states of calibration, GPS location of the device, image processing specifiers specific to that device or location, or watermark parameters, and the like. These parameters are defined herein as “people identification, equipment identification, material identification or secure document production geographical location associated with production of the secure document and all of which are not generally known to the public.” These items would be very difficult to predict or detect after the fact by someone trying to produce fraudulent secure documents or “beat the system.” Only the system could have generated and stored these data for validation or verification later with the hardcopy output embedded information detected at scanning. This metadata information is sent to a central database site 70 for populating a central database 80 via a network connection, either a wire or wireless connection.

As way of example only, the secure document holder would then present the secure identification 45 to official authorities at an airport 55, such as airline enforcement authorities, for authentication. The official authorities would then scan the secure document 45 for retrieving the watermark by a scanner 60. The scanner 60 could have any suitable watermark retrieval algorithm. Such algorithms are well known in the art and will not be discussed in detail herein. In any event, such an algorithm is disclosed in U.S. Pat. No. 6,278,791B1, which is entitled Lossless Recovery of An Original Image Containing Embedded Data, by Honsinger et al., and assigned to the Eastman Kodak Company. The scanner 60 includes a network connection, typically either a wire connection or a wireless connection, to a central database site 70 having a central database 80 that contains all of the metadata embedded in all the secure documents 45 by the authorized secure document producer. The scanner 60 sends the metadata obtained from the watermark to the central database site 70 that then verifies the metadata. The central database 80 verifies that the metadata is correct or that the metadata is incorrect, which, if incorrectly, indicates that secure document 45 may be fraudulent. This information is then sent back to the scanner 60, which includes a graphical display for displaying compliance or noncompliance of the metadata. The official authorities can then take appropriate actions based on the displayed authentication results.

The invention has been described with reference to a preferred embodiment. However, it will be appreciated that variations and modifications can be effected by a person of ordinary skill in the art without departing from the scope of the invention.

Parts List

10 secure document system
20 image capture facility
30 digital camera
40 personal computer
45 secure document
50 digital output
55 official site (i.e. airport)
60 scanner
70 central database site
80 central database

1. A method for verifying the authenticity of a secure document, the method comprising the steps of:
(a) encoding the secure document with one or more of steganographically encoded people identification, equipment identification, material identification or secure-document, production geographical location all associated with production of the secure document and all of which are not generally known to the public for forming metadata;
(b) scanning a secure document for obtaining the metadata:
(c) verifying the metadata with a database; and
(d) accepting identification by correctly matching one or more of the provided metadata.

2. The method as in claim 1, wherein the step of encoding the metadata includes the step of either individually or in any combination encoding a global positioning identification, captured equipment identification, printer or media/material identification, operator identification and image processing specification, look-up table for capture or output, device operation status, or printing identification that form the metadata.

3. The method as in claim 2, wherein step (d) includes correctly matching each of the metadata.

4. The method as in claim 1, step (a) of encoding the secure document includes disposing a visible element, in lieu of the steganographically, encoded metadata, having the metadata on the secure document.

5. The method as in claim 1 further comprising the step of providing either an identification badge, driver's license, birth certificate, passport, visa, certificate of authenticity, legal document, diploma, currency or stocks and bonds as the secure document.

6. A system for verifying an authentication of a secure document, the system comprising:
(a) a secure document creation system for creating the secure document having metadata steganographically encoded from one or more of either people identification, equipment identification, material identification or secure document production geographical location associated with production of the secure document and all of which are not generally known to the public for forming secure-document metadata;
(b) a metadata database having the secure-document metadata; and
(c) a retrieving device for reading the secure document and retrieving the encoded metadata for verifying the retrieved secure-document metadata against the secure-document metadata in the database.

7. The system as in claim 6,wherein the secure-document metadata include either individually or in any combination a global positioning identification, captured equipment identification, printer or media/material identification, operator identification and image processing specification, look-up table for capture or output, device operation status, or printing identification that forms the secure-document metadata.

8. The system as in claim 6 further comprising a software-based algorithm which steganographically encodes and decodes the metadata embedded in the secure document.

9. The system as in claim 6, wherein the secure document creation system for creating the secure document includes a visible element disposed on the secure document, in lieu of steganographically encoded metadata, for forming the metadata.
